(19) United States
(12) Patent Application Publication
(10) Pub. No.: US 2012/0144391 A1
(43) Pub. Date: Jun. 7, 2012

(54) PROVISIONING A VIRTUAL MACHINE

(75) Inventor: Yohei Ueda, Kanagawa-ken (JP)

(73) Assignee: International Business Machines Corporation, Armonk, NY (US)

(21) Appl. No.: 13/307,144

(22) Filed: Nov. 30, 2011

(30) Foreign Application Priority Data
Dec. 2, 2010 (JP) 2010-268890

(51) Int. Cl. G06F 9/455

(52) U.S. Cl. 718/1

(57) ABSTRACT

An information processing system which includes: a storage controlling module in any of computer apparatuses that runs a clone origin virtual machine, where the storage controlling module controls: booting up the clone origin virtual machine when the clone origin virtual machine is detached from a virtual network interface; acquiring running state information indicating a running state of the clone origin virtual machine; and storing an image including the running state information and virtual disk information in a storage apparatus; and a boot controlling module in any of computer apparatuses that creates a clone virtual machine, where the boot controlling module controls: resuming at least one of the clone virtual machines with the image when each of the clone virtual machines is detached from the virtual network interface; and attaching the virtual network interface to the at least one clone virtual machine.

### CROSS-REFERENCE TO RELATED APPLICATION

This application claims priority under 35 U.S.C. §119 from Japanese Patent Application No. 2010-268890 filed Dec. 2, 2010, the entire contents of which are incorporated herein by reference.

### BACKGROUND OF THE INVENTION

1. Field of the Invention

The present invention relates to a virtualization technology. More particularly, the present invention relates to an information processing system, an information processing apparatus, a virtual machine provisioning method, and a recording medium for promptly provisioning a virtual machine.

2. Description of Related Art

In recent years, system virtualization technologies for virtualizing hardware resources including a CPU (Central Processing Unit), memory, storage and the like of a computer have been developed. In addition, technologies that involve building a virtual computer, i.e. a virtual machine on the resources, have been developed. Along with the development of the aforementioned virtualization technologies and recent advancement in Internet technologies, a cloud service, such as so-called IaaS (Infrastructure as a Service), is prevalent today. The cloud service, as a service via the Internet, provides an infrastructure including the above virtual machine, a network, and the like. IaaS, as described above, allows its service users to increase or decrease the number of web server instances at appropriate times corresponding to web server traffic. IaaS also allows its service users to increase or decrease the number of data node instances of a distributed batch processing system that corresponds to a data scale of batch processing. Thus, a system capable of expanding or reducing the performance promptly with a change in the load is provided.

In the aforementioned system, an operating system (hereinafter, referred to as an “OS”) and software are installed in a file system image (hereinafter, referred to as an “OS image”), and the file system image is deployed to host machines (Japanese Patent Application Publication No. 2005-292922, and Japanese Patent Application Publication No. 2009-230655). Then, a virtual machine is booted on each of the host machines with the received OS image on the host machine. In this way, necessary server instances are provisioned. In a case where multiple virtual machines are provisioned from a single OS image, the same boot process is repeated until a required number of virtual machines are booted.

The boot process usually generates random disk I/O (input/output) operations, but is a slow process in general. Thus, booting up a large number of server instances requires a long period of time. In addition, the boot process consumes bandwidth for the disk I/O, and thus, can interfere with another virtual machine running on the resource, on which the boot process is in progress. Such interference is undesirable because it can cause inconvenience to another user's system. Therefore, increase in speed and efficiency for booting up a virtual machine is an important point in differentiating a cloud service.

One possible technique for speeding up the booting of a virtual machine is to copy running state information on the virtual machine, where the running state information includes values of a memory and registers of the virtual machine in a running state. The above copy technique allows cloning the virtual machine in the running state. This technique can skip the booting, and can enable reduction in the I/O operations. However, a virtual machine that has been in a running state for a prolonged period of time keeps stateful information, which can include an IP (Internet Protocol) address and the internal state of an application. As a result, the keeping of the stateful information does not allow copying of such stateful information described above. Thus, the cloning of the virtual machine of the state without stateful information is problematic and inappropriate.

Furthermore, another known technique for speeding up the boot process of a virtual machine relates to JVM (Java (registered trademark) Virtual Machine), which is a type of process virtualization and is disclosed in Japanese Patent Application Publication No. 2007-293730. Japanese Patent Application Publication No. 2005-292922 discloses an information terminal that is capable of running a virtual machine and is configured: to monitor data I/O operations of an application by the virtual machine during the execution of the application; to store I/O records such as the number, types and data amounts of the I/O operations; to determine whether or not and how to perform a memory dump from certain I/O records; and to dump the entirety or a part of a memory image of the virtual machine executing the application.

The technique disclosed in Japanese Patent Application Publication No. 2007-293730 relates to process virtualization in which a JVM on an information terminal acquires a memory dump of an application to shorten the launch time of the application. The technique employs a configuration to suspend a JVM whenever any of I/O events such as writing to a file, writing to a display output device, and a key input occur for the first time during the boot process. The technique then acquires a memory dump. However, the system virtualization is different from the process virtualization in that the first I/O event occurs at an extremely early stage of the boot process. For this reason, even if the above technique disclosed in Japanese Patent Application Publication No. 2007-293730 is applied to the system virtualization, the actual speed-up of the boot process can be barely obtained.

Furthermore, Japanese Patent Application Publication No. 2005-292922 and Japanese Patent Application Publication No. 2009-230655 disclose techniques to deploy an OS image more efficiently, but the techniques are targeted for processing prior to the start of the boot process. Accordingly, Japanese Patent Application Publication No. 2005-292922 and Japanese Patent Application Publication No. 2009-230655 disclose nothing about the speed-up of the boot process from a deployed OS image.

A technique to rewrite network setting after a virtual machine is booted is conceivable in consideration of the problem of the aforementioned stateful information. However, the network setting is written in a memory where an OS kernel and an application are allocated, so that the internal structure of such software cannot be simply rewritten from outside. Even if the rewriting is allowed, the technique largely relies on the OS environment. Additionally, even if a management tool as disclosed in “RHEL5.4 KVM Automatic Copying of Virtual Machine,” [online], [searched on Nov. 25, 2010], the Internet <URL: http://www-06.ibm.com/jp/domino01/mkt/cnpages7.nsf/page/default-0004E0BB> is used to create a clone of a virtual machine and to change the network setting configuration file in the virtual disk, the network of the virtual machine in the running state cannot be changed. Accordingly, the same boot process needs to be repeated in this instance as a result. In cases where the setting file is cached in a memory, the virtual machine in a running state can rewrite the file on the virtual disk only, and causes cache inconsistency as a result.

Accordingly, in order to promptly provide a server instance to a service user in IaaS described above, a provisioning technique for a system virtual machine is demanded, where the provisioning technique is capable for booting up multiple virtual machines based on a single OS image in a short period of time without adding load on another virtual machine running on the same host machine.

### SUMMARY OF THE INVENTION

Accordingly, one aspect of the present invention provides an information processing system, the system including: a storage controlling module in any of computer apparatuses that runs a clone origin virtual machine, where the storage controlling module controls: booting up the clone origin virtual machine when the clone origin virtual machine is detached from a virtual network interface; acquiring running state information indicating a running state of the clone origin virtual machine; and storing an image including the running state information and virtual disk information in a storage apparatus; and a boot controlling module in any of computer apparatuses that creates a clone virtual machine, where the boot controlling module controls: resuming at least one of the clone virtual machines with the image when each of the clone virtual machines is detached from the virtual network interface; and attaching the virtual network interface to the at least one clone virtual machines.

Another aspect of the present invention provides an information processing apparatus including: a system virtualization controlling module for abstracting hardware resources and providing an execution infrastructure of a virtual machine; a storage module for storing an image comprising (i) running state information indicating a running state of a clone origin virtual machine and (ii) virtual disk information, where the image does not have setting information about a virtual network interface that is to be attached to the clone origin virtual machine; a resume module for resuming a required number of clone virtual machines by using the image in a state of each of the clone virtual machines being detached from the virtual network interface on the system virtualization controlling module; and an attachment module for attaching the virtual network interface to a resumed clone virtual machine on the system virtualization controlling module.

Another aspect of the present invention provides a method for provisioning at least one virtual machine on the at least one computer apparatus, the method including the steps of: booting up a clone origin virtual machine when the clone origin virtual machine is detached from a virtual network interface; acquiring running state information that indicates a running state of the clone origin virtual machine in a state after the clone origin virtual machine is booted; storing an image that comprises the running state information and virtual disk information in a storage apparatus; resuming at least one clone virtual machines by using the image when the at least one clone virtual machines is detached from the virtual network interface; and attaching the virtual network interface to resumed at least one clone virtual machines, where the steps of booting, acquiring, and storing are carried out by a computer apparatus that runs the clone origin virtual machine; and where the steps of resuming and attaching are carried out by a computer apparatus that creates the clone virtual machine.

### BRIEF DESCRIPTION OF THE DRAWINGS

FIG. 1 is a schematic diagram of a provisioning system according to an embodiment of the present invention.

FIG. 2 is a block diagram showing a hardware configuration and a software configuration of a host machine in the present embodiment.

FIG. 3 is a conceptual diagram for describing virtual machine provisioning processing according to the embodiment of the present invention.

FIG. 4 is a block diagram of functions relating to load processing, the functions being realized in the provisioning system according to the embodiment of the present invention.

FIG. 5 is a block diagram of functions relating to boot process, the functions being realized in the provisioning system according to the embodiment of the present invention.

FIG. 6 is a flowchart showing load processing executed by a host machine that creates a clone virtual machine in the provisioning system according to the embodiment of the present invention.

FIG. 7 is a flowchart showing the boot process executed by the host machine that creates the clone virtual machine in the provisioning system according to the embodiment of the present invention.

FIG. 8 is a diagram for describing update processing of a state file.

FIG. 9 is a diagram illustrating a captured state file.

FIG. 10 is a graph drawn by plotting the time required for the provisioning processing for the number of virtual machine to be booted.

### DETAILED DESCRIPTION OF THE PREFERRED EMBODIMENT

Hereinafter, a description will be given of the present invention by using an embodiment. The present invention, however, is not limited to the embodiment to be described below. In the embodiment to be described below, a provisioning system, which includes multiple host machines and a repository server having a storage apparatus, will be described as an example of an information processing system including one or more computer apparatuses and a storage apparatus. The provisioning system is provided for provisioning a virtual machine in a cloud environment, where computing performance, via the virtual machine, is provided to a user as a service via the Internet.

The above and other features of the present invention will become more distinct by a detailed description of embodiments shown in combination with attached drawings. Identical reference numbers represent the same or similar parts in the attached drawings of the invention.

As will be appreciated by one skilled in the art, aspects of the present invention can be embodied as a system, method or computer program product. Accordingly, aspects of the present invention can take the form of an entirely hardware embodiment, an entirely software embodiment (including firmware, resident software, micro-code, etc.) or an embodiment combining software and hardware aspects that can all generally be referred to herein as a “circuit,” “module” or “system.” Furthermore, aspects of the present invention can take the form of a computer program product embodied in one or more computer readable medium(s) having computer readable program code embodied thereon.

Any combination of one or more computer readable medium(s) can be utilized. A computer readable storage medium can be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium can include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium can be any tangible medium that can contain, or store a program for use by or in connection with an instruction execution system, apparatus, or device.

Computer program code for carrying out operations for aspects of the present invention can be written in any combination of one or more programming languages, including an object oriented programming language such as Java, Smalltalk, C++ or the like and conventional procedural programming languages, such as the “C” programming language or similar programming languages. The program code can execute entirely on the user's computer, partly on the user's computer, as a stand-alone software package, partly on the user's computer.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions can also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions can also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams can represent a module, segment, or portion of code, which includes one or more executable instructions for implementing the specified logical function(s). It should also be noted that, in some alternative implementations, the functions noted in the block can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated. The present invention has been made in view of the aforementioned conventional problems and aims to provide an information processing system, an information processing apparatus and a virtual machine provisioning method, where each of which is capable for booting up multiple virtual machines from a single OS image in a short period of time without adding load on another virtual machine running on the same host machine. In addition, the present invention aims to provide a program for implementing the information processing apparatus and a recording medium in which the program is recorded.

In order to solve the problem with the aforementioned conventional technique, the present invention provides an information processing system having the following characteristic features. This information processing system includes one or more computer apparatuses and a storage apparatus. A computer apparatus of one or more computer apparatuses that run a clone origin virtual machine performs control of booting up the clone origin virtual machine in a state of being detached from a virtual network interface, acquiring running state information indicating a running state of the clone origin virtual machine and storing an image including the running state information and virtual disk information in the storage apparatus. In addition, the computer apparatus of the one or more computer apparatuses that creates a clone virtual machine performs control of resuming one or more clone virtual machines in a state of being detached from a virtual network interface by using the aforementioned image, and attaching the virtual network interface to the one or more clone virtual machines after resuming the one or more clone virtual machines.

More specifically, the aforementioned booting up control can be control of copying the image stored in the storage apparatus onto the computer apparatus, updating unique information included in the aforementioned running state information (a fixed-length identifier that uniquely identifies a virtual machine or a fixed-length path of a virtual disk which is uniquely assigned to a virtual machine, for example) sequentially for each of the clone virtual machines to be booted on the computer apparatus and resuming the virtual machine from the updated image.

Furthermore, according to the present invention, it is possible to provide a virtual machine provisioning method, an information processing apparatus that can be operated as a clone origin computer apparatus and a computer apparatus that creates a clone virtual machine, or any one of the computer apparatuses, and a program for implementing the information processing apparatus, as well as a recording medium for recording the program therein. Note that, the aforementioned storage apparatus can be included in a repository server connected to the aforementioned one or more computer apparatuses via a network, or can be a storage apparatus included in any one of the aforementioned one or more computer apparatuses.

According to the aforementioned configuration, one or more virtual machines are provisioned on a computer apparatus from an image loaded from a clone origin virtual machine without using a normal boot process generating random I/O operations, in a form that a copy of the clone origin virtual machine is resumed. Accordingly, it is possible to boot up one or more virtual machines in a short time as compared with a case where the normal boot process is used. Moreover, since the load caused by disk I/O operations is reduced, interference to another virtual machine running on the same computer apparatus is reduced.

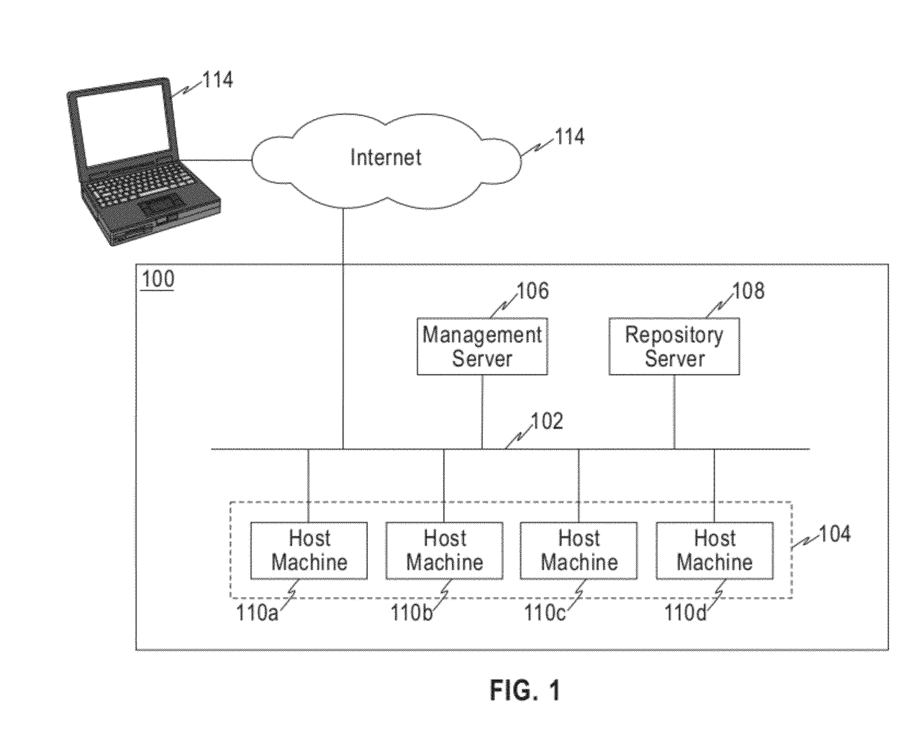

The aforementioned image is loaded from the clone origin virtual machine after the clone origin virtual machine is booted in a state of being detached from a virtual network interface. Thus, the image holds no stateful information such as network setting. Accordingly, the problems of stateful information and identical clones operating simultaneously are not caused. In addition, upon attachment of a virtual network interface, a guest OS of the virtual machine automatically recognizes the virtual network interface and assigns a network address or the like. Thus, this technique can be said to be OS independent. FIG. 1 is a schematic diagram of a provisioning system according to an embodiment of the present invention. The provisioning system 100 includes: a host machine group 104, a management server 106 and a repository server 108 each of which is connected to a network 102. The host machine group 104 is formed of at least one host machines 110a to 110d each including hardware resources such as a processor and a memory. Virtualization software is installed in each of the host machines 110, and the hardware resources provided by the aforementioned host machine 110 are abstracted by the virtualization software. Thus, a virtualized computer, i.e., a virtual machine is realized on the physical resources.

The repository server 108 provides a storage area for permanently storing a file image in which an operating system (hereinafter, referred to as an “OS”) and software are installed (hereinafter, referred to as an “OS image”). The service user can select an OS image he or she wants to use from previously prepared various OS images. The user can further create a custom OS image obtained by customizing a template OS image and then save the customized OS image in the aforementioned repository server 108. With a normal provisioning method, each virtual machine is booted from an OS image through a predetermined boot process.

Moreover, the repository server 108 according to the embodiment of the present invention provides a storage area for permanently storing a capture image including virtual memory data or the like (not that, in this description, hardware virtualized and assigned to each virtual machine is referred to with a term “virtual” in some cases in order to distinguish the hardware from physical hardware) captured from a virtual machine in a running state, as will be described later in detail. With the provisioning method according to the embodiment of the present invention, the virtual machines are booted from a previously prepared capture image as described later in more detail.

The aforementioned network 102 is an internal network on a service provider side and is not limited to any particular network. The network 102 can include a LAN (Local Area Network) by TCP/IP or Ethernet (registered trademark), for example. Moreover, the network 102 can be configured as a wide area network configured by connecting together LANs at different locations via a dedicated line or a public line using a VPN (Virtual Private Network) in another embodiment.

The aforementioned network 102 is connected to the Internet 112 via a not-shown router and a security layer such as a firewall. The management server 106 provides a manager on a service user side with a management portal site for using the service. In addition, the management server 106 includes a management application for processing various requests issued via the management portal site by the manager on a service user side. The management server 106 also collects and manages information about a virtualization environment built on the host machine group 104 and performs remote management of virtualization software operating on each of the host machines 110, in accordance with a request from the aforementioned manager. The service user accesses the management server 106 via the Internet 112 by using a client terminal 114 and thus can make a capture image creation application for a virtual machine and a virtual machine provision application and can also set a trigger condition used as a trigger to increase or decrease the number of virtual machines or the like.

The management server 106 and the repository server 108 are each generally configured as a general-purpose computer apparatus such as a workstation, a rack mountable server and a blade server. Specifically, each of the management server 106 and the repository server 108 includes hardware resources such as a CPU of a single core processor, a multi-core processor or the like, a cache memory, a RAM, a network interface card (NIC) and a storage device. The management server 106 and the repository server 108 respectively provide as a management interface and a storage service of the virtualization environment, functions under control of an appropriate OS such as Windows (registered trademark), UNIX (registered trademark), and LINUX (registered trademark).

The client terminal 114 is generally configured as a computer apparatus such as a tower type, desktop type, laptop type or tablet type personal computer, a workstation, a netbook and a PDA (Personal Digital Assistance). The client terminal 114 includes hardware resources such as the aforementioned CPU and operates under control of an appropriate OS such as Windows (registered trademark), UNIX (registered trademark), LINUX (registered trademark), Mac OS (registered trademark), and AIX (registered trademark). In this embodiment, a web browser operating on the aforementioned OS is installed in the client terminal 114.

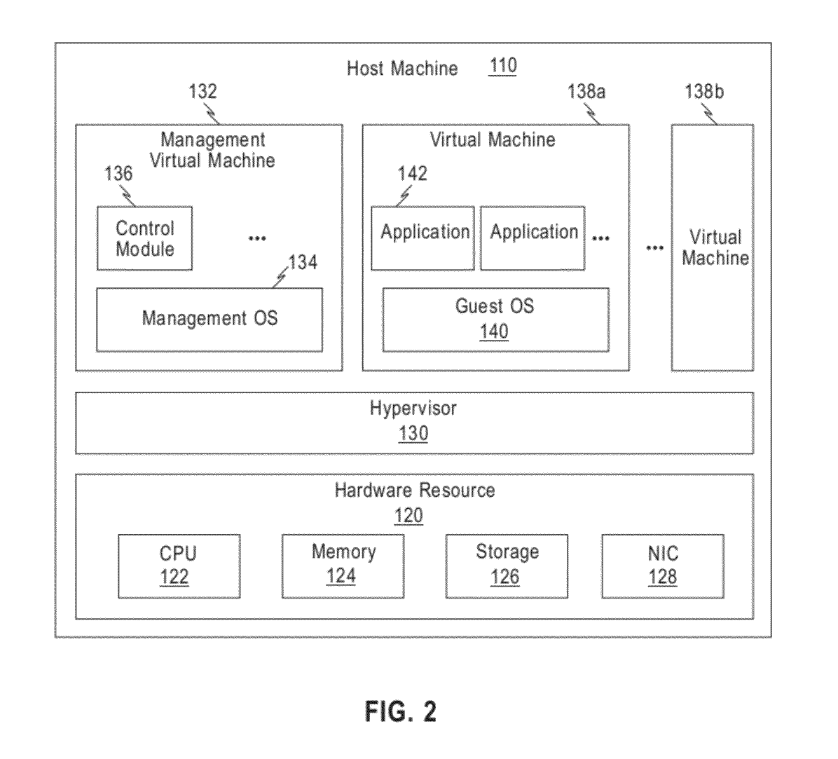

Hereinafter, a description will be given of a configuration of the host machine 110 on which a virtual machine runs. FIG. 2 is a block diagram showing a hardware configuration and a software configuration of the host machine in the provisioning system according to the present embodiment. The host machine 110 is generally configured as a general-purpose computer apparatus such as a workstation, a rack mountable server, a blade server, a midrange and a mainframe. The host machine 110 includes a central processing unit (CPU) 122, a memory 124, a storage 126 such as a hard disk drive (HDD) or a solid-state drive (SSD), and a NIC 128, as hardware resources 120.

The host machine 110 includes a hypervisor (also called a virtual machine monitor in some cases) 130 of virtualization software operating on the hardware resource 120, such as Xen (registered trademark), VMWare (registered trademark) and Hyper-V (registered trademark). Then, virtual machines 132, 138 using various OSes such as Windows (registered trademark), UNIX (registered trademark) and LINUX (registered trademark) as a guest OS run on this hypervisor 130.

Note that, the aforementioned virtualization software can employ bare-metal architecture as shown in FIG. 2 but the employable architecture is not limited in particular. Another architecture, such as a host architecture, can be employed in another embodiment. Furthermore, when employing bare-metal architecture, the hypervisor 130 can employ any one of full-virtualization and para-virtualization approaches and also can employ any one of monolithic kernel and micro kernel systems as a device driver implementation system.

The virtual machine 132 is a management virtual machine so called domain-0, parent partition or the like. The management virtual machine 132 is configured of a management OS 134 and a control module 136 operating on the management OS 134. The control module 136 is a module that receives an instruction from the management server 106 and issues a command to the hypervisor 130 on the host machine 110 on which the control module 136 operates. The control module 136 issues an instruction to create a user domain virtual machine so called domain-U, child partition, or the like or to boot a guest OS to the hypervisor 130 in response to the instruction from the management server 106, for example, and controls the operation of the virtual machine under management by the management server 106.

Virtual machines 138a, 138b are user domain virtual machines each providing computing performance to a service user. Each of the virtual machines 138 includes a guest OS 140 and various applications 142 operating on the guest OS 140. The guest OS 140 and the applications 142 included in the virtual machine 138 depend on the service user and any combination of the OS and applications is employable. As the aforementioned applications 142, various applications for executing a web server, distributed batch processing, database management, image processing and the like are employable but are not limited in particular. The virtual machine 138 serves as a data node instance in a web server or a distributed batch processing system in accordance with the applications 142 included therein.

The aforementioned virtual machine 138 is provisioned by a predetermined method in response to a virtual machine provisioning application from a service user or an event that the trigger condition used as a trigger to increase the number of virtual machines and set by the service user is satisfied. After completion of the provisioning, the service user can directly access the virtual machine 138 from the Internet 112 without using the management server 106. The method for accessing the virtual machine 138 is not limited in particular, and a terminal emulator can be used to access the virtual machine 138. In addition, in a case where the virtual machine 138 includes a web application, a web site is built by the aforementioned provisioning, so that the service user can access the virtual machine 138 by logging into the site by using a browser.

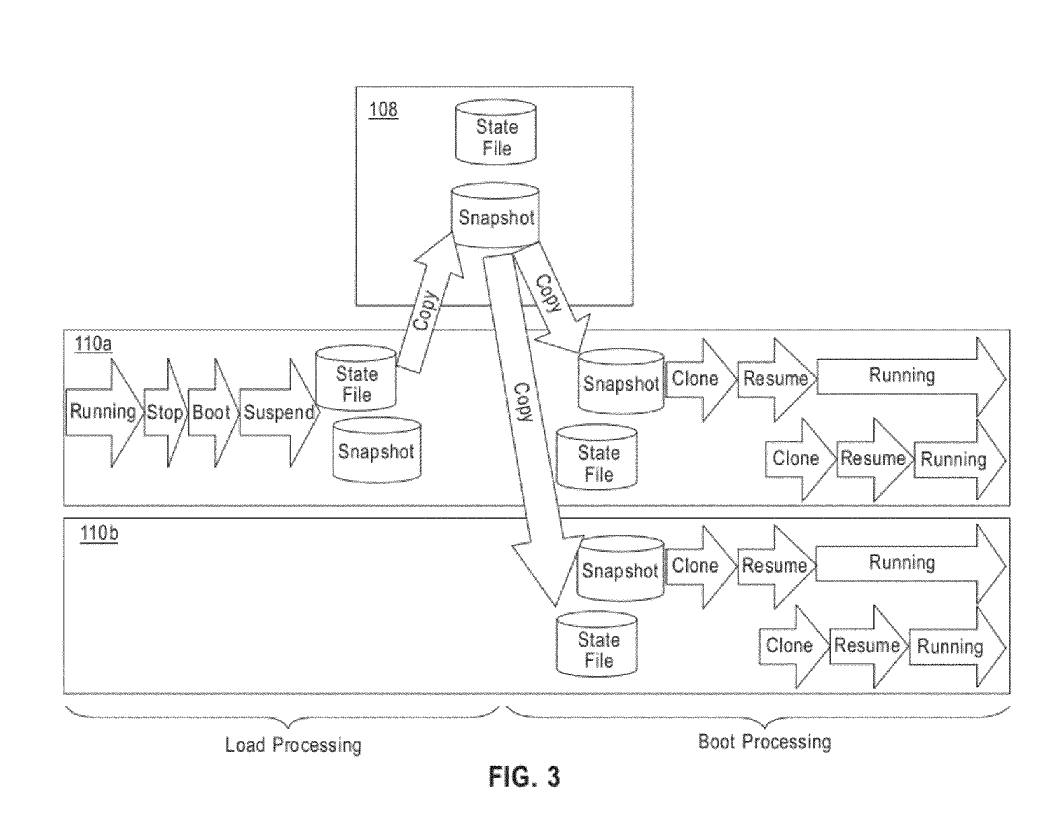

In the provisioning system 100 according to the embodiment of the present invention, in addition to a normal method for booting up the virtual machine 138 through a predetermined boot process from a previously prepared OS image, a method for booting up the virtual machine 138 by using a capture image loaded from a virtual machine in a running state, without using a normal boot process is provided as a virtual machine provisioning method. Hereinafter, a description will be given in detail of the virtual machine provisioning processing according to the embodiment of the present invention with reference to FIG. 3 to FIG. 9.

FIG. 3 is a conceptual diagram for the virtual machine provisioning processing according to the embodiment of the present invention to perform provisioning of multiple virtual machines on the host machine group 104 by using a capture image. With the provisioning processing according to the embodiment of the present invention, at least one clone virtual machines copied from a designated virtual machine are booted on the host machine group 104. This provisioning processing is configured of load processing that creates a capture image as a requirement and boot process that boots up a virtual machine from the capture image.

The aforementioned load processing is performed on the host machine 110 (host machine 110a, for example) on which a clone origin virtual machine operates, and a capture image of the clone origin virtual machine is created by the load processing. Specifically, in the load processing according to the embodiment of the present invention, the clone origin virtual machine in a running state (Running) is temporarily shut down (Stop); the clone origin virtual machine is rebooted (Boot) in a state of being detached from a virtual NIC; the clone origin virtual machine is suspended (Suspend) in the state immediately after the boot; and the capture image is temporarily stored in a storage apparatus. The created capture image is stored in the repository server 108 (Copy) and is then distributed to the host machine 110 that creates the clone virtual machine. Specifically, the aforementioned capture image is formed of running state information including device configuration, virtual CPU register values and virtual memory data of the virtual machine, and virtual disk information including virtual root disk data of the virtual machine. The aforementioned running state information is acquired by the hypervisor 130 on the host machine 110 as a VM state file (hereinafter, simply referred to as a “state file”). Here, no IP address is assigned to the virtual machine in the state immediately after the virtual machine is rebooted in a state of being detached from a virtual NIC. Thus, the capture image loaded while the virtual machine is in the state immediately after the virtual machine is rebooted includes no information about the network setting of the virtual NIC, which is the stateful information.

The virtual disk information can be the contents of the virtual root disk in which an OS and the like are installed, but in terms of shortening the time to create the image and reducing the size of the image, a disk snapshot (hereinafter, simply referred to as a “snapshot”) of the virtual root disk by a copy-on-write function included in the hypervisor 130 can be used.

The aforementioned boot process is performed on each of the host machines 110 that creates a clone virtual machine, and at least one clone virtual machines are booted on each of the host machines 110 from a single capture image by the boot process. Specifically, in the boot process according to the embodiment of the present invention, each of the host machines 110 copies (Copy) a state file and a snapshot onto the storage 126 of the host machine 110 from the repository server 108, first. Note that, in the example shown in FIG. 3, the host machines 110a, 110b are illustrated as the computer apparatuses each creating a clone virtual machine and a capture image is copied onto each of the host machines 110a, 110b. However, in a case where a computer apparatus operates as both the clone origin computer apparatus and the computer apparatus that creates a clone virtual machine, as in the case of a host machine A110a, the copy processing using the repository server 108 is not necessarily performed.

In the boot process according to the embodiment of the present invention, subsequently, each of the host machines 110 repeats processing to update a state file and to newly create a snapshot of a virtual root disk (Clone) for each virtual machine, then to resume a virtual machine from the updated state file (Resume) and then to perform predetermined customization processing after the resume processing, until a required number of virtual machines as a whole are booted. Each clone virtual machine resumed from the aforementioned capture image is in a state of being detached from a virtual NIC and is assigned no IP address. For this reason, each of the host machines 110 performs processing to attach a virtual NIC to each clone virtual machine as the aforementioned customization processing. Accordingly, the guest OS of each clone virtual machine recognizes the attached virtual NIC by plug-and-play and assigns an IP address.

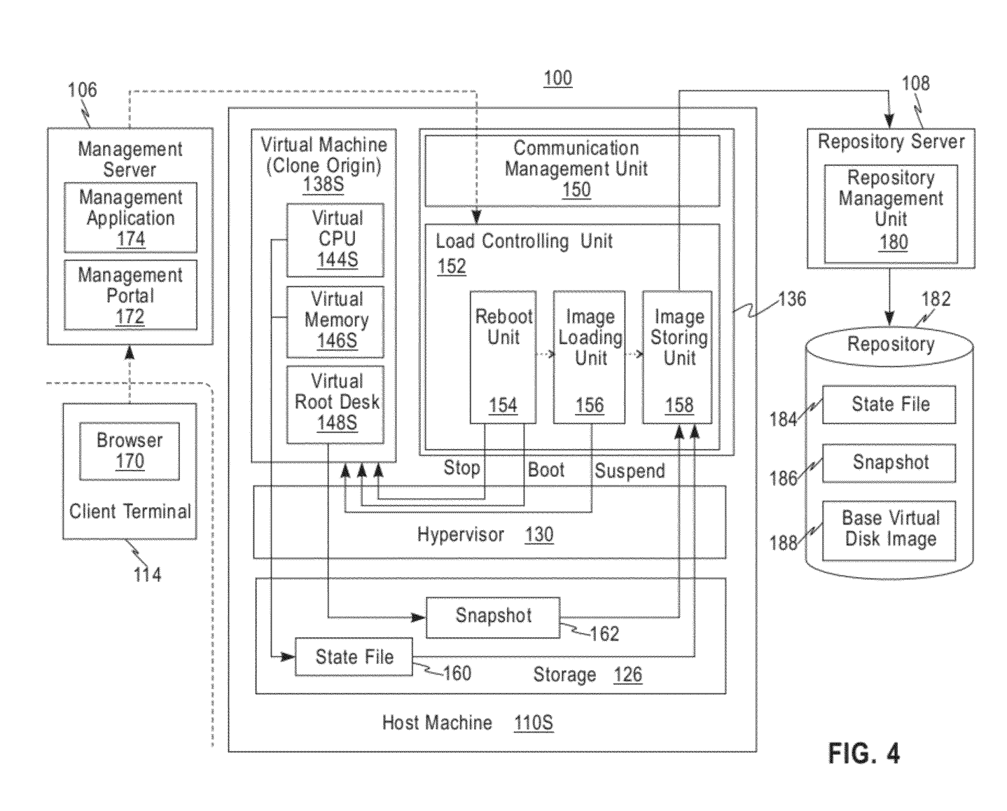

Hereinafter, a description will be given of the virtual machine provisioning processing according to the embodiment of the present invention in detail with reference to a functional block diagram of the provisioning system 100. FIG. 4 is a diagram showing functions relating to load processing, the functions being realized in the provisioning system according to the embodiment of the present invention. FIG. 4 shows the management server 106, the repository server 108, the client terminal 114 and a host machine 110S on which a clone origin virtual machine 138S operates.

The management server 106 includes a management portal 172 for providing a service management interface, and a management application 174 for processing various requests issued via the management portal 172 by the service user. The management portal 172 of the present embodiment is implemented as a web server, and a manager on the service user side accesses the management portal 172 by the HTTP protocol by using a browser 170 of the client terminal 114 and thus can issue various requests from a management menu. The aforementioned requests include selection of the OS image to be introduced into the virtual machine and selection of the specification of the virtual machine, as well as a capture image creation application for the virtual machine, a virtual machine provision application, setting of a trigger condition used as a trigger to increase or decrease the number of virtual machines, and the like. Note that, the management portal 172 and the management application 174 form a receiving unit and a provision instructing unit, respectively, in the embodiment of the present invention.

Note that, for convenience of description, a description is given here with an assumption that the manager on the service user side has already selected the OS image and the specification of the clone origin virtual machine and that the clone origin virtual machine 138S has already started running on the host machine 110S. When the manager on the service user side issues a capture image creation application for the clone origin virtual machine 138S via the management portal 172, the request is passed to the management application 174 from the management portal 172, and the management application 174 issues an instruction to perform the load processing to the clone origin host machine 110S.

The control module 136 operating on the host machine 110 is configured of a communication management unit 150 configured to manage communications with the management server 106 and the repository server 108, and a load controlling unit 152 configured to perform the load processing. Note that, the load controlling unit 152 forms a storage controlling unit in the embodiment of the present invention. When the communication management unit 150 receives the instruction to perform the load processing from the management application 174, the instruction is passed to the load controlling unit 152. The aforementioned instruction to perform the load processing includes identification information that identifies the clone origin virtual machine 138S, and the load controlling unit 152 thus starts processing to create a capture image of the designated clone origin virtual machine 138S.

Specifically, the load controlling unit 152 includes a reboot unit 154 configured to reboot the clone origin virtual machine 138S, an image loading unit 156 configured to load an image of the clone origin virtual machine 138S and an image storing unit 158 configured to store a capture image in the repository server 108. The reboot unit 154 issues a shutdown instruction (Stop) for the clone origin virtual machine 138S in a running state to the hypervisor 130 and issues a reboot instruction (boot) for the clone origin virtual machine 138S after the definition file of the virtual machine is rewritten in such a way that the virtual machine is booted in a state of being detached from a virtual NIC for preparation of creation of the capture image.

The capture image includes the contents of the virtual memory as the running state information but when the virtual memory of the clone origin virtual machine 138S has a large amount of unused area, the capture image is unnecessarily enlarged by the amount. Thus, in a preferred embodiment, the definition file of the virtual machine can be further rewritten in such a way that the size of the virtual memory assigned to the virtual machine can be reduced, before the reboot instruction for the clone origin virtual machine 138S is issued.

The reduction in size of the aforementioned virtual memory beforehand can reduce the disk I/O operations in the boot process because the unused area in the storage capacity assigned to the clone origin virtual machine is reduced, and the storing time and the copy time of the image are reduced. In addition, in a case where a data disk is attached to the clone origin virtual machine 138S, the definition file of the virtual machine can be rewritten in such a way that the data disk can be detached from the virtual machine, before the reboot instruction for the clone origin virtual machine 138S is issued.

The image loading unit 156 issues a suspend instruction (Suspend) or a hibernation instruction (Hibernate) to the hypervisor 130 immediately after the clone origin virtual machine 138S is booted in a state of being detached from a virtual NIC. Note that, the state immediately after the clone origin virtual machine 138S is booted herein refers to a state where the clone origin virtual machine 138S is in a normal running state except that a data disk is detached, after a virtual NIC is detached and a virtual memory 146S is appropriately reduced. Meanwhile, if any one of the applications 142 includes a function to recognize the added NIC and to dynamically perform setting, the aforementioned state refers to a state where this application 142 is launched. In a case where the virtual machine operates as a web server instance, and the web server has a function to dynamically perform setting of an additional NIC, for example, the aforementioned state refers to a state after the web server has started running.

Upon receipt of the suspend instruction, the hypervisor 130 stops the clone origin virtual machine 138S in a running state and writes the register values of a virtual CPU 144S and the data of the virtual memory 146S of the clone origin virtual machine 138S to the storage 126 as a state file 160. The image storing unit 158 reads the state file 160 stored in the storage 126 and further acquires a snapshot 162 of a virtual root disk 148S and makes a store request for a capture image to the repository server 108 via the communication management unit 150. In response to the store request, a repository management unit 180 of the repository server 108 stores a state file 184 and a snapshot 186 in a repository 182.

Note that, the snapshots 162, 186 correspond to difference data acquired from the virtual root disk 148S by copy-on-write, and a base virtual disk image serving as the base of the virtual root disk 148S previously stored in the repository 182, for example, and is used for distribution to a host machine 110T that creates the clone virtual machine. As described, the contents of the virtual root disk 148S are separately managed as a base virtual disk image 188 shared among the host machines 110 beforehand and the snapshot 186 reflecting the latest state. Accordingly, the creation time of the capture image is shortened, and the size of the image can be reduced as well.

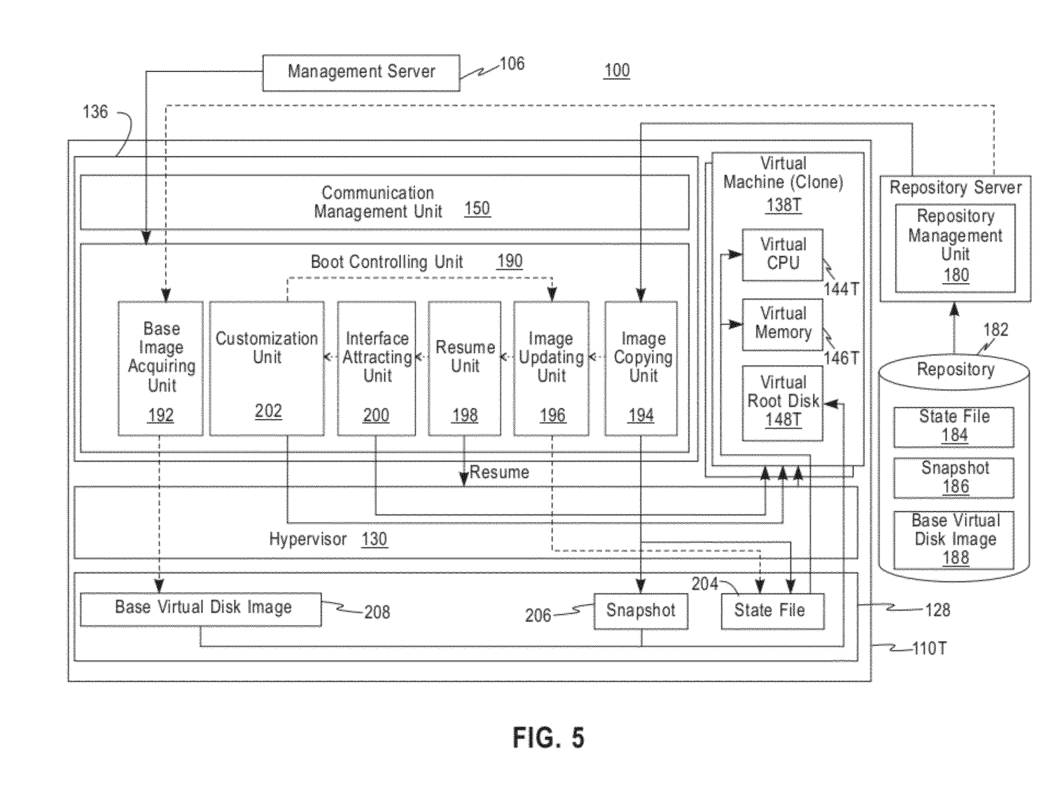

FIG. 5 is a diagram showing functional blocks relating to boot process, the functional blocks being realized in the provisioning system according to the embodiment of the present invention. FIG. 5 shows the management server 106, the repository server 108, and the host machine 110T that creates the clone virtual machine. When the service user issues a provision request for the virtual machine from the capture image through the management portal 172, the request is passed to the management application 174 from the management portal 172. Upon receipt of the request, the management application 174 determines the host machine 110T that creates a clone virtual machine among the host machine group 104 and then issues an instruction to perform the boot process to the host machine 110T that creates a clone virtual machine.

Note that, the host machine 110T that creates a clone virtual machine is determined in accordance with user designated information such as the number of virtual machines or a location where the virtual machine is executed (area or a partition in an area), which is designated by the manager when the provision application is made, as well as environment information such as a location where each of the host machines 110 is installed or a load condition thereof, but how the host machine 110T that creates a clone virtual machine is determined is not limited in particular. In addition, the number of the host machines 110T each creating a clone virtual machine to be determined is not limited to one, and a desired number of the host machines 110T each creating a clone virtual machine is determined in order to prepare the number of virtual machines required as a whole.

The control module 136 operating on the host machine 110T that creates a clone virtual machine includes the communication management unit 150 and a boot controlling unit 190 configured to perform the boot process. When the communication management unit 150 receives an instruction to perform the boot process from the management application 174, the instruction is passed to the boot controlling unit 190. The instruction to perform the boot process includes information on the number of virtual machines to be provisioned on the host machines 110T that creates a clone virtual machine (hereinafter, referred to as a “required number”) and information that identifies the capture image. The boot controlling unit 190 starts the processing to boot up the required number of clone virtual machines from the designated capture image.

Specifically, the boot controlling unit 190 includes a base image acquiring unit 192, an image copying unit 194, an image updating unit 196, a resume unit 198, an interface attaching unit 200 and a customization unit 202. The base image acquiring unit 192 previously acquires the base virtual disk image 188 from the repository server 108 and stores the base virtual disk image 188 in the storage 126. The image copying unit 194 acquires the state file 184 and the snapshot 186 in the repository 182 from the repository server 108 and stores the state file 184 and the snapshot 186 in the storage 126.

The image updating unit 196 updates, for each clone virtual machine to be provisioned, virtual machine unique information included in a state file 204 (hereinafter, referred to as unique information) copied to the storage 126 and creates a snapshot for each clone virtual machine by copying an acquired snapshot 206. The aforementioned unique information to be updated includes a VMID (Virtual Machine Identifier), which identifies a virtual machine, and a path of the virtual root disk assigned to the virtual machine. Meanwhile, if there is another unique information other than the aforementioned VMID and the path of the virtual root disk, such as a name of the virtual machine, for example, the information is updated as well. The virtual root disk 148S of each clone virtual machine is restored from the base virtual disk image 208 and the snapshot created for each clone virtual machine.

The resume unit 198 issues a resume instruction (Resume) to resume a clone virtual machine from the updated state file 204 to the hypervisor 130 for each clone virtual machine to be provisioned. In response to the resume instruction, the hypervisor 130 resumes the virtual machine 138T by restoring the register values of the virtual CPU 144T and restoring the data of the virtual memory 146T from the updated state file 204. Note that, the virtual machine 138T is resumed from the state immediately before the capture image is created from the clone origin virtual machine 138S, i.e., the state where the virtual machine becomes a normal running state except for attachment of the virtual NIC, appropriate enlargement of the virtual memory and attachment of the data disk. In a case where any of the applications 142 of the virtual machine 138T has the function to recognize the added NIC and to dynamically perform setting, the virtual machine 138T is resumed from the state where the application 142 is launched.

The interface attaching unit 200 issues an instruction to attach the virtual NIC to the clone virtual machine 138T to the hypervisor 130 after the clone virtual machine 138T is resumed in a state of being detached from the virtual NIC. When the virtual NIC is attached to the virtual machine 138T, a guest OS of the virtual machine 138T recognizes the virtual NIC and performs network setting such as assignment of an IP address and the like. In a case where the virtual machine 138T operates as a web server instance, and the web server has a function to dynamically perform setting for the added NIC, the web server performs network setting for the recognized virtual NIC in response to attachment of the aforementioned virtual NIC and starts the service.

The customization unit 202 performs customization processing other than attachment of the virtual NIC for each virtual machine to be provisioned. The other customization processing can include resizing of the virtual memory 146T, attachment of a data disk, and execution of another custom script. In this case, the customization unit 202 issues an instruction to enlarge the virtual memory 146T or to attach a data disk, to the hypervisor 130 as appropriate. When resizing of the virtual memory 146T of the clone virtual machine 138T is performed, the guest OS of the virtual machine 138T recognizes that the storage area is changed. Moreover, when a data disk is attached to the clone virtual machine 138T, the guest OS of the virtual machine 138T recognizes and configures the data disk.

With the configuration to create a capture image after reducing the size of the virtual memory 146S during the aforementioned load processing and then to enlarge the size of the virtual memory 146T to the original size during the boot process, it is made possible to reduce the size of the capture image, i.e., to further reduce the disk I/O operations during provisioning and to further reduce interference to another virtual machine on the same host machine.

The processing by the aforementioned image updating unit 196, the resume unit 198, the interface attaching unit 200 and the customization unit 202 is repeatedly performed for the number of virtual machines to be provisioned, thereby provisioning the required number of virtual machines on the host machine 110T that creates a clone virtual machine. Note that, the processing to be performed by the aforementioned image updating unit 196, the resume unit 198, the interface attaching unit 200 and the customization unit 202 can be performed in parallel for the virtual machines. As described later in more detail, in terms of efficiently recycling the state file 204, it is desirable to perform at least the processing to update the state file and the processing to resume the clone virtual machine, which are performed by the image updating unit 196 and the resume unit 198, in parallel between different host machines, and in sequence on the same host machine for the virtual machines.

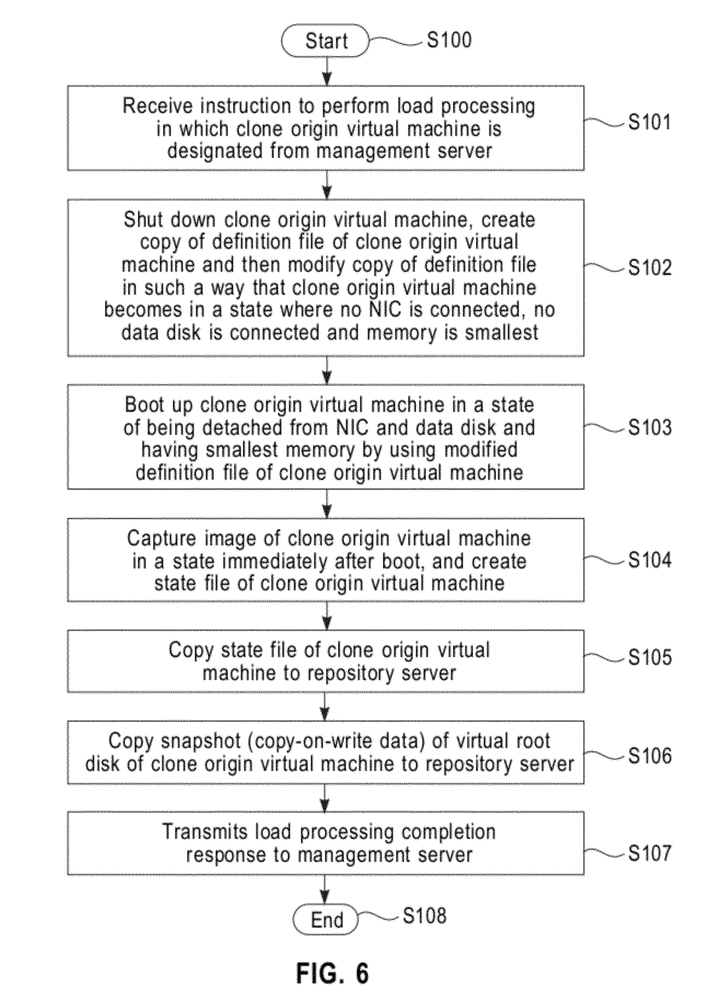

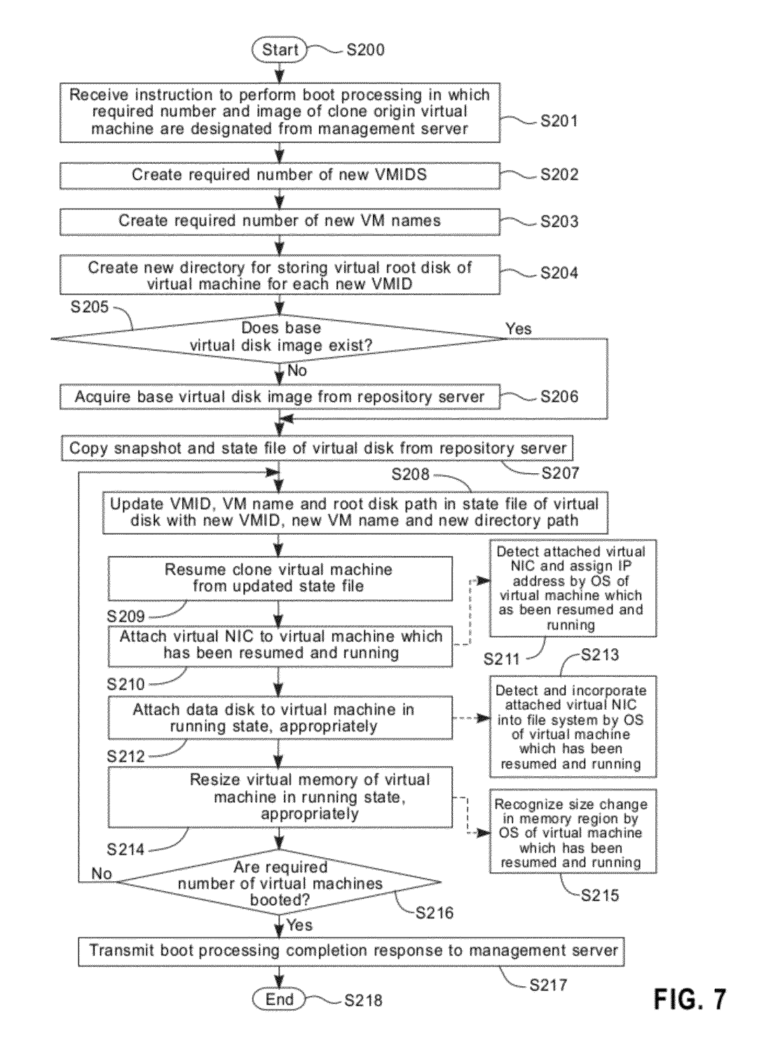

Hereinafter, a flow of the provisioning processing performed in the embodiment of the present invention will be described in more detail with reference to FIGS. 6 and 7. FIG. 6 is a flowchart showing load processing executed by the host machine 110S that creates a clone virtual machine in the provisioning system according to the embodiment of the present invention. The processing shown in FIG. 6 starts from step S100 in response an event where a manager on a service user side issues a capture image creation application to the management server 106, and the management server 106 thus issues an instruction to perform the load processing.

In step S101, the host machine 110S receives the instruction to perform the load processing in which the clone origin virtual machine 138S is designated from the management server 106. In step S102, by using the reboot unit 154, the host machine 110S shuts down the designated clone origin virtual machine 138S, creates a copy of the definition file of the clone origin virtual machine 138S and then modifies the copy of the definition file in such a way that the clone origin virtual machine 138S becomes in a state where no NIC is connected, no data disk is connected and the memory is smallest. In step S103, the host machine 110S boots up the clone origin virtual machine 138S in a state of being detached from an NIC and a data disk and having the configuration of the smallest memory by using the reboot unit 154 using the modified definition file of the clone origin virtual machine 138S.

In step S104, the host machine 110S captures an image of the clone origin virtual machine 138S in the state immediately after the boot, and writes the state file 160 and the snapshot 162 to the storage 126 by using the image loading unit 156. The host machine 110S copies the state file 160 of the clone origin virtual machine 138S to the repository server 108 by using the image storing unit 158 in step S105 and copies the snapshot (copy-on-write data) 162 of the virtual root disk to the repository server 108 in step S106. The host machine 110S transmits a load processing completion response to the management server 106 in step S107 and then ends the load processing in step S108.

FIG. 7 is a flowchart showing the boot process executed by the host machine 110T that creates the clone virtual machine in the provisioning system according to the embodiment of the present invention. The processing shown in FIG. 7 starts from step S200 in response to an event where a provisioning application is made to the management server 106 from the service user side, or a previously set trigger condition used as a trigger to increase the number of virtual machines is satisfied, and an instruction to perform the boot process is issued from the management server 106 to the host machine 110T that creates a clone virtual machine.

Note that, the aforementioned trigger condition is not limited in particular, and can be set as a condition for an index value of the CPU utilization, the network load, the amount of disk usage or the like of the virtual machine. In a system of the service user, for example, a condition to add a web server instance can be set while an average network load on the web server instances is monitored, with the average load becoming equal to or greater than a certain amount set as the trigger. Thus, it is made possible to expand the scale of the web system seamlessly in accordance with a transitional increase in the access amount.

In step S201, the host machine 110T that creates a clone virtual machine receives an instruction to perform the boot process in which a required number of virtual machines to be provisioned on the host machine 110T and the clone origin capture image are designated. The host machine 110T creates a required number of new VMIDs in step S202 and creates a required number of new VM names in step S203 and creates a new directory for storing the virtual root disk of the virtual machine for each of the new VMIDs in step S204.

In step S205, the host machine 110T determines whether or not a base virtual disk image 208 exists in the storage 126 of the host machine 110T. If the host machine 110T determines that no base virtual disk image 208 exists (NO) in step S205, the processing proceeds to step S206. In step S206, the host machine 110T acquires a base virtual disk image 188 from the repository server 108 by using the base image acquiring unit 192, and then stores the base virtual disk image 188 in the storage 126, then the processing proceeds the processing to step S207.

On the other hand, when a base virtual disk image 208 is cached, and the host machine 110T thus determines that there is a base virtual disk image 208 (YES) in step S205, the processing directly proceeds to step S207. In step S207, the host machine 110T acquires a state file 184 and a snapshot 186 from the repository server 108 and then copies the state file 184 and the snapshot 186 in the storage 126 by using the image copying unit 194.

In step S208, by using the image update unit 196, the host machine 110T updates the VMID and VM name and the path of the virtual root disk in the state file 204 with a corresponding one of the new VMIDs and VM names and the new directory paths, which are created in steps S202 to S204 described above.

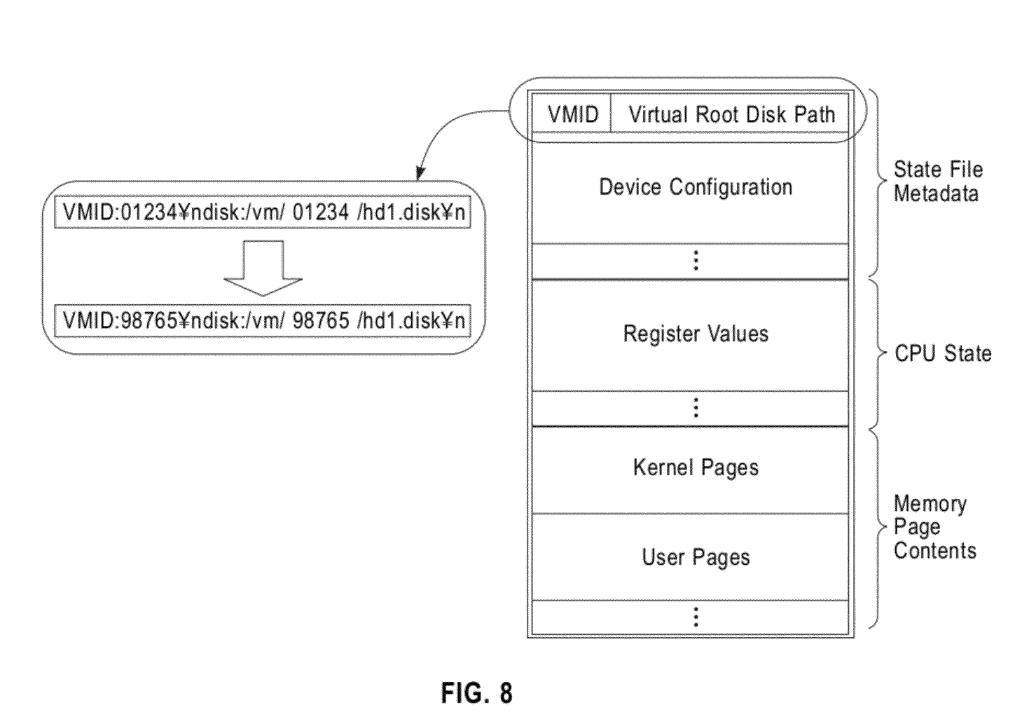

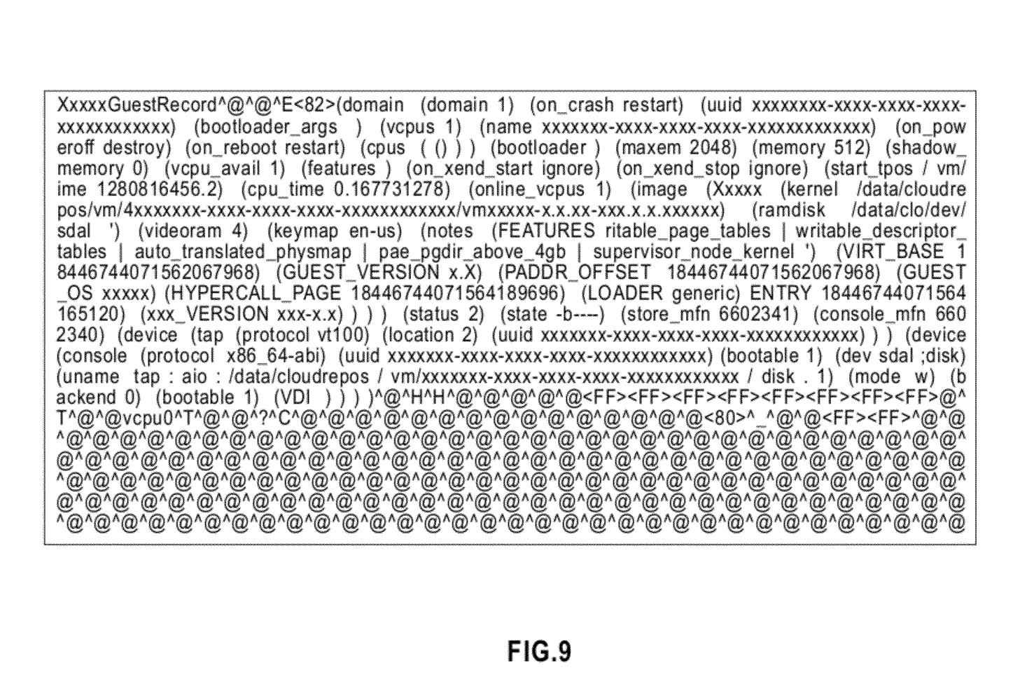

FIG. 8 is a diagram for describing update processing of a state file. FIG. 9 is a diagram illustrating a captured state file. As shown in FIGS. 8 and 9, the state file is sequential data including a metadata portion (State File Metadata), a CPU data portion (CPU State) including the CPU register values (Register Values) and a memory data portion (Memory Page Contents) including a kernel area (Kernel pages) and a user area (User Pages).

The aforementioned metadata portion includes a field in which an identifier (VMID) uniquely identifying a virtual machine is stored, a field in which a path of a virtual root disk (Virtual Root Disk Path) is stored, and an area in which a device configuration is described. In FIG. 9, the portion written by boldface type, “xxxxxxxx-xxxx-xxxx-xxxx-xxxxxxxxxxxx” in the state file shows the character string of the VMID included in the VMID and VM name (identical to the VMID in FIG. 9) of the clone origin virtual machine and the path of the virtual root disk.

Since the state file is sequential data in which the metadata portion, the CPU data portion and the memory data portion arranged continuously, if the lengths of these portions change due to the updating of the VMID and the path of the virtual root disk in the state file, the state file needs to be rewritten entirely. To put it differently, the state file needs to be prepared for each virtual machine. Meanwhile, if the lengths of the VMID and the path of the virtual root disk are each set to a fixed length, the length of the aforementioned character string does not change. Thus, a state file required for resuming the subsequent clone can be obtained by updating a single state file for each time resuming of a clone virtual machine is completed.

Accordingly, in a preferred embodiment, a fixed-length UUID (Universally Unique IDentifier) character string can be used as a VMID, and in step S202, a random and fixed-length identifier unique to a virtual machine can be created by a using a library such as uuidgen program. Likewise, for the new VM names, it is possible to create a random and fixed-length name unique to a virtual machine by using a similar library. Likewise, for the path of the virtual root disk for each of the new VMIDs, it is possible to create a fixed-length path unique to a virtual machine by creating the path with the aforementioned fixed length VMID included in a part of the path in step S204. Then, in step S208, the VMID and VM name and the path of the virtual root disk in the state file 204 are replaced with the created new fixed-length VMID and VM name and the path of the new directory by inplace processing. Thus, it is made possible to prepare the state file for each required virtual machine without changing the file size and without copying the state file for each virtual machine. In FIG. 9, the state file required for booting each virtual machine can be prepared by only replacing the portion indicated by boldface type “xxxxxxxx-xxxx-xxxx-xxxx-xxxxxxxxxxxx” in the state file with a newly created VMID (VM name).

In step S209, the host machine 110T restores the virtual CPU 144T and the virtual memory 146T from the updated state file 204 and resumes the clone virtual machine by using the resume unit 198. In step S210, the host machine 110T attaches a virtual NIC to the virtual machine which has been resumed and running, by using the interface attaching unit 200. In response to step S210, the guest OS 140 of the virtual machine which has been resumed and running detects the attached virtual NIC and assigns an IP address in step S211.

In step S212, the host machine 110T attaches, by using the customization unit 202, a data disk to the virtual machine which has been resumed and running. In response to step S212, the guest OS 140 of the virtual machine which has been resumed and running detects the attached virtual NIC and configures the data disk in step S213. In step S214, the host machine 110T resizes, by using the customization unit 202, the virtual memory 146T of the virtual machine which has been resumed and running. In response to step S214, the guest OS 140 of the virtual machine which has been resumed and running recognizes the changed memory size in step S215. In step S216, the host machine 110T determines whether or not the required number of virtual machines are booted. In step S216, if it is determined that the required number of virtual machines are not yet booted (NO), the processing is looped to step S208 and is repeated until the required number of virtual machines are booted. Accordingly, the VMID character string (indicated by boldface type “xxxxxxxx-xxxx-xxxx-xxxx-xxxxxxxxxxxx”) in the state file is sequentially replaced with the new VMID generated for each virtual machine, and each virtual machine is sequentially resumed from the updated state file.

On the other hand, if it is determined in step S216 that the required number of virtual machines are booted (YES), the processing proceeds to step S217. In step S217, the host machine 110T transmits a boot process completion response to the management server 106 and the boot process is terminated in step S218.

According to the embodiment described above, virtual machines 138T are provisioned on the host machine 110 without using a normal boot process generating random disk I/O operations from a capture image loaded from the clone origin virtual machine 138S, in a form that a copy of the clone origin virtual machine is resumed. Accordingly, as compared with a case where a normal boot process is used, the virtual machines can be booted in a short time, and since the load caused by disk I/O operations is reduced, interference to another virtual machine running on the same host machine 110 is reduced.

The aforementioned capture image is loaded from the clone origin virtual machine 138S after the clone origin virtual machine 138S is booted in a state of being detached from a virtual NIC. Thus, the image holds no stateful information such as network setting. Accordingly, problems of stateful information and identical clones operating simultaneously are not caused. In addition, upon attachment of a virtual NIC, a guest OS of the virtual machine automatically recognizes the virtual NIC and assigns an IP address or the like. Thus, this technique can be said to be OS independent.

Note that, the aforementioned embodiment is described with the assumption that the state file, the snapshot and the base virtual disk image are each distributed to the host machines 110 via the repository server 108, but they are not necessarily distributed through the repository server 108. In another embodiment, it is possible to employ a configuration in which the aforementioned state file, snapshot and base virtual disk image are shared between the clone origin host machine 110S and at least one host machines 110T each creating a clone virtual machine, by using a peer-to-peer communication scheme.

Hereinafter, a description will be given of the provisioning processing according to the embodiment of the present invention with a specific example. However, the present invention is not limited to the example described below.

### Example

A program for implementing the provisioning system 100 according to the aforementioned embodiment on a computer system formed of multiple computer apparatuses was created, and the time until a predetermined number of virtual machines are provisioned was measured and then compared with that in a conventional technique to thereby evaluate the provisioning technique according to the embodiment of the present invention.

As the host machines 110, a total of four units of IBM (registered trademark) BladeCenter (registered trademark) HS22 of IBM Corporation, each of which is configured of physical resources including eight cores, 24 GB DDR3 (Double Data Rate 3) RAM and 500 GB HDD, were used to form the host machine group 104. As the repository server 108, IBM (registered trademark) BladeCenter (registered trademark) HS21 of IBM Corporation was used. The four host machines (HS22) and the repository server (HS21) were connected with each other by inserting a 10 GbE (10 gigabit Ethernet (registered trademark)) network expansion card into a CFFh high-speed expansion slot. Xen (registered trademark) was used as the virtualization software. The virtual machine used a Linux (registered trademark) kernel image as the guest OS and is configured of a single core virtual CPU, a 512 MB virtual memory and a 10 GB virtual storage.

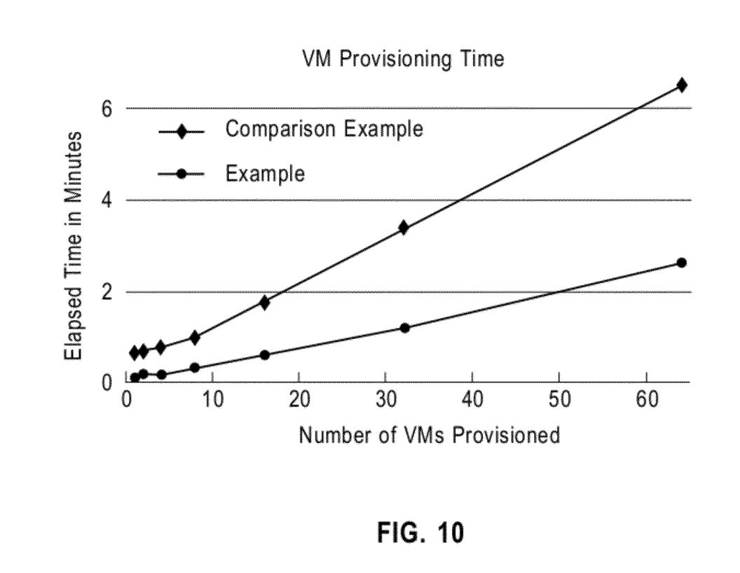

A base virtual disk image was previously distributed to each of the host machines 110, and VM state files and corresponding copy-on-write data (snapshots) were stored in the repository server 108. During the provisioning processing, the VM state files and corresponding copy-on-write data (snapshots) were copied from the repository server 108 to each of the host machines 110. Then, 1, 2, 4, 8, 16, 32, and 64 virtual machines as a whole were sequentially booted by using the VM state files and corresponding copy-on-write data (snapshots). Then, the time required for all the virtual machines to be booted was measured for each case. FIG. 10 shows a graph drawn by plotting the time required with the provisioning processing according to the embodiment of the present invention for each number of booted virtual machines.

### Comparison Example

The physical resources, the virtualization software and the virtual machine were configured in the same manner as in the case of the aforementioned example. The OS image was previously distributed to the host machines 110, and 1, 2, 4, 8, 16, 32, and 64 virtual machines were sequentially booted using a normal boot process from the OS image. Then, the time required for all the virtual machines to be booted was measured for each case. Note that, the boot processes of the virtual machines were performed in parallel. In FIG. 10, the time required with the provisioning processing of the comparison example was plotted for each number of booted virtual machines. As shown in FIG. 10, it was proved that booting up of the virtual machines was completed by the provisioning processing of the example with the time shorter than the time required in the case of the provisioning processing of the comparison example, in a range up to 64 virtual machines as a whole. In addition, it was notably shown that the effect of shortening the boot time was particularly large in a range where a larger number of virtual machines are booted.

As described above, according to the embodiment of the present invention, it is possible to provide an information processing system, an information processing apparatus and a virtual machine provisioning method each of which makes it possible to boot up multiple virtual machines based on a single OS image in a short time without adding load on another virtual machine running on the same host machine. In addition, it is possible to provide a program for implementing the information processing apparatus, and a recording medium for recoding the program therein.

The provisioning system according to the embodiment of the present invention is provided by loading a computer-executable program on a computer apparatus and thus implementing each of the function units. Such a program can be achieved by a computer-executable program written in a legacy programming language or an object-oriented programming language, such as FORTRAN, COBOL, PL/I, C, C++, Java (registered trademark), Java (registered trademark) Beans, Java (registered trademark) Applet, Java (registered trademark) Script, Perl or Ruby, for example. The program can be stored in a machine-readable recording medium and thus be distributed.

Hereinabove, the present invention has been described with the embodiment and example shown in the drawings. However, the present invention is not limited to the embodiment shown in the drawings, and it is possible to make a change such as another embodiment, addition, change, deletion or the like within a range that those skilled in the art can easily conceive. In any aspect, as long as the operational effects of the present invention are brought about, such a change is included in the scope of the present invention.

What is claimed is:

1. An information processing system, comprising:
a storage controlling module in any of computer apparatuses that runs a clone origin virtual machine, wherein said storage controlling module controls: booting up said clone origin virtual machine when said clone origin virtual machine is detached from a virtual network interface; acquiring running state information indicating a running state of said clone origin virtual machine; and storing an image comprising said running state information and virtual disk information in a storage apparatus; and
a boot controlling module in any of computer apparatuses that creates a clone virtual machine, wherein said boot controlling module controls: resuming at least one of said clone virtual machines with said image when each of said clone virtual machines is detached from said virtual network interface; and attaching said virtual network interface to said at least one clone virtual machines.

2. The system according to claim 1, wherein said boot controlling module controls:
copying said image stored in said storage apparatus onto said computer apparatus;
sequentially updating unique information in said running state information for each of said clone virtual machines to be booted by said computer apparatus; and
resuming a virtual machine from an updated image.

3. The system according to claim 2, wherein:
said storage controlling module performs processing to reduce a size of a virtual memory of said clone origin virtual machine before acquiring said running state information; and
said boot controlling module further performs customization processing, wherein said customization processing comprises resizing of a virtual memory for each of said clone virtual machines after resuming said clone virtual machine.

4. The system according to claim 3, wherein:
said virtual disk information comprises a snapshot of a virtual disk of said clone origin virtual machine; and
said computer apparatus that creates said clone virtual machine comprises a storage module for storing a disk image that serves as a base of a difference shown by said snapshot of said virtual disk of said clone origin virtual machine.

5. The system according to claim 2, wherein:
said unique information comprises a fixed-length identifier that uniquely identifies said virtual machine and a fixed-length path of a virtual disk uniquely assigned to said virtual machine;
said image is sequential: and
said updating of said unique information comprises replacing, without changing size of said image, said fixed-length identifier and said fixed-length path in said image with an identifier and a path that are unique to a clone virtual machine to be booted.

6. The system according to claim 1, further comprising a management server comprising:
a receiver for receiving a virtual machine provision application and/or setting of a condition to be used as a trigger to increase the number of virtual machines; and
a provision instructing module for issuing an instruction to provision a required number of virtual machines to each of said boot controlling modules in said computer apparatuses if said virtual machine provision application is received or said condition is satisfied.

7. The system according to claim 1, further comprising a repository server for managing an image of a virtual machine, wherein said image of a virtual machine is stored in said storage apparatus.

8. The system according to claim 1, wherein said running state information of said image comprises unique information, register values of a virtual processor, and data on a virtual memory.

9. An information processing apparatus, comprising:
a system virtualization controlling module for abstracting hardware resources and providing an execution infrastructure of a virtual machine;
a storage module for storing an image comprising (i) running state information indicating a running state of a clone origin virtual machine and (ii) virtual disk information, wherein said image does not have setting information about a virtual network interface that is to be attached to said clone origin virtual machine;
a resume module for resuming a required number of clone virtual machines by using said image in a state of each of said clone virtual machines being detached from said virtual network interface on said system virtualization controlling module; and
an attachment module for attaching said virtual network interface to a resumed clone virtual machine on said system virtualization controlling module.

10. The apparatus according to claim 9, further comprising:
a copy module for copying said image stored in an external storage device to said storage module; and
an update module for sequentially updating unique information in said image stored in said storage module for each of said required number of said clone virtual machines to be booted,
wherein said resume module sequentially resumes said virtual machines from updated images.

11. The apparatus according to claim 9, further comprising:
a virtual disk storage module for storing a disk image serving as a base of a virtual disk of said clone origin virtual machine, wherein
said virtual disk information comprises a snapshot of said virtual disk of said clone origin virtual machine.

12. The apparatus according to claim 9, further comprising a customization module for performing customization processing that comprises resizing of a virtual memory for each of said clone virtual machines on said system virtualization controlling module after resuming said clone virtual machine.

13. A method for provisioning at least one virtual machine on the at least one computer apparatus, the method comprising the steps of:
booting up a clone origin virtual machine when said clone origin virtual machine is detached from a virtual network interface;
acquiring running state information that indicates a running state of said clone origin virtual machine in a state after said clone origin virtual machine is booted;
storing an image that comprises said running state information and virtual disk information in a storage apparatus;
resuming at least one clone virtual machines by using said image when said at least one clone virtual machines is detached from said virtual network interface; and
attaching said virtual network interface to resumed at least one clone virtual machines,
wherein said steps of booting, acquiring, and storing are carried out by a computer apparatus that runs said clone origin virtual machine; and
wherein said steps of resuming and attaching are carried out by a computer apparatus that creates said clone virtual machine.

14. The method according to claim 13, further comprising the steps of:
copying said image stored in said storage apparatus onto said computer apparatus; and
updating unique information in copied image for said clone virtual machine, wherein:
said steps of copying and updating are carried out by said computer apparatus that creates said clone virtual machine;
said resuming step resumes said virtual machine from an updated image; and
said updating step and said resuming step are iterated sequentially for at least one of said clone virtual machines to be booted by said computer apparatus.

15. The method according to claim 13, further comprising the step of:
enlarging a size of a virtual memory assigned to said clone origin virtual machine, wherein said step of booting further comprises the step of reducing said size of said virtual memory assigned to said clone origin virtual machine.

16. The method according to claim 13, further comprising the steps of:
detecting connection of said virtual network interface; and
assigning a network address to said clone virtual machine in response to attachment of said virtual network interface to said clone virtual machine,
wherein said steps of detecting connection and assigning a network address are carried out by an operating system of a resumed clone virtual machine.

17. A computer readable storage medium tangibly embodying a computer readable program code having non-transitory computer readable instructions which, when implemented, cause a computer to carry out the steps of claim 13.
